(19) United States
(12) Patent Application Publication
(10) Pub. No.: US 2026/0194500 A1
(43) Pub. Date: Jul. 9, 2026

(54) METHOD AND APPARATUS FOR MATERIAL ANALYSIS

(71) Applicant: SAMSUNG ELECTRONICS CO., LTD., Suwon-si (KR)

(72) Inventors: Dongyeeb SHIN, Suwon-si (KR); Hyukju Kwon, Suwon-si (KR); Dongseon Lee, Suwon-si (KR)

(73) Assignee: SAMSUNG ELECTRONICS CO., LTD., Suwon-si (KR)

(21) Appl. No.: 19/259,221

(22) Filed: Jul. 3, 2025

(30) Foreign Application Priority Data
Jan. 7, 2025 (KR) 10-2025-0002332

(51) Int. Cl. G01N 30/72; G01N 30/02; G01N 30/16

(52) U.S. Cl. CPC G01N 30/724; G01N 30/16; G01N 2030/027; G01N 2030/167

(57) ABSTRACT

Provided is a method of analyzing a material based on liquid chromatography, the method including determining a mobile phase solvent and a stationary phase column based on information of a sample, controlling conditioning of a fluid path based on an analytical index of the fluid path corresponding to the stationary phase column configured to receive the mobile phase solvent, injecting the mobile phase solvent and an eluent of the sample into the stationary phase column based on a determination whether the sample includes a target material, and outputting a liquid chromatography analysis result corresponding to the eluent and the stationary phase column.

### CROSS-REFERENCE TO RELATED APPLICATION

This application claims priority to Korean Patent Application No. 10-2025-0002332, filed on Jan. 7, 2025, in the Korean Intellectual Property Office, the disclosure of which is incorporated herein in its entirety by reference.

### BACKGROUND

### 1. Field

Embodiments of the present disclosure relate to a method and apparatus for material analysis.

### 2. Description of Related Art

Chromatography is configured such that a sample that has been injected into a measurement device is separated over time by interaction of a mobile phase and a stationary phase for measurement, which is a method of quantitative and qualitative analysis using the characteristics that components included in the sample exhibit each different detection time (peak time) under the same measurement condition and in the same measurement device. When a sample that is a mixture of various components is mixed with the mobile phase and brought to the stationary phase, the detection time of each component may vary because their movement speed in passing the stationary phase is different depending on the characteristics of each component. A specific material may be separated from a sample or materials included in the sample may be separated by each component through chromatography.

### SUMMARY

One or more embodiments provide a method and apparatus for material analysis.

One or more embodiments may address at least the above problems and/or disadvantages and other disadvantages not described above. Also, the embodiments are not required to overcome the disadvantages described above, and an embodiment may not overcome any of the problems described above.

According to an aspect of one or more embodiments, there is provided a method of analyzing a material based on liquid chromatography, the method including determining a mobile phase solvent and a stationary phase column based on information of a sample, controlling conditioning of a fluid path based on an analytical index of the fluid path corresponding to the stationary phase column configured to receive the mobile phase solvent, injecting the mobile phase solvent and an eluent of the sample into the stationary phase column based on a determination whether the sample includes a target material, and outputting a liquid chromatography analysis result corresponding to the eluent and the stationary phase column.

The injecting of the eluent into the stationary phase column may include determining whether the sample includes the target material based on a measurement result of a mass-to-charge ratio (m/z) of the sample, and injecting the eluent into the stationary phase column based on a result of the determining.

The determining of the mobile phase solvent and the stationary phase column may include determining a protocol based on information of the target material corresponding to the sample, and determining the mobile phase solvent and the stationary phase column corresponding to the determined protocol.

The outputting of the liquid chromatography analysis result may include outputting the liquid chromatography analysis result based on an output by a detector for each material of a plurality of materials separated from the sample based on liquid chromatography.

The detector may include at least one of an ultraviolet-visible (UV-VIS) spectrophotometer, a mass spectrometer, and a charged aerosol detector (CAD).

The outputting of the liquid chromatography analysis result may include acquiring chromatography data of a plurality of materials separated from the sample based on liquid chromatography.

The acquiring of the chromatography data may include acquiring chromatography data corresponding to an ultraviolet-visible absorbance of the plurality of materials separated from the sample based on liquid chromatography.

The acquiring of the chromatography data may include acquiring chromatography data corresponding to an electric charge of a charged aerosol of each material of the plurality of materials separated from the sample based on liquid chromatography.

The method may further include acquiring mass spectra corresponding to peaks of the chromatography data, based on mass spectrometry for the plurality of materials separated.

The method may further include determining, based on the acquired mass spectra, a peak corresponding to the target material among peaks detected from the chromatography data.

The outputting of the liquid chromatography analysis result may include based on the information of the sample, determining an analytical index of each material of a plurality of materials separated from the sample based on liquid chromatography, and outputting an analysis result corresponding to the determined analytical index that corresponds to each material of the plurality of materials.

According to another aspect one or more embodiments, there is provided a non-transitory computer readable medium storing a computer program, when executed by at least one processor, cause an electronic device to perform a method of analyzing a material based on liquid chromatography, the method including determining a mobile phase solvent and a stationary phase column based on information of a sample, controlling conditioning of a fluid path based on an analytical index of the fluid path corresponding to the stationary phase column configured to receive the mobile phase solvent, injecting the mobile phase solvent and an eluent of the sample into the stationary phase column, and outputting a liquid chromatography analysis result corresponding to the eluent and the stationary phase column.

According to still another aspect one or more embodiments, there is provided an electronic device including at least one processor, and a memory configured to store instructions, wherein the instructions, when executed by the at least one processor, cause the electronic device to determine a mobile phase solvent and a stationary phase column based on information of a sample, control conditioning of a fluid path based on an analytical index of the fluid path corresponding to the stationary phase column configured to receive the mobile phase solvent, inject the mobile phase solvent and an eluent of the sample into the stationary phase column based on a determination whether the sample includes a target material, and output a liquid chromatography analysis result corresponding to the eluent and the stationary phase column.

The injecting of the eluent into the stationary phase column may include determining whether the sample includes the target material based on a measurement result of a mass-to-charge ratio (m/z) of the sample, and injecting the eluent into the stationary phase column based on a result of the determining.

The determining of the mobile phase solvent and the stationary phase column may include determining a protocol based on information of the target material corresponding to the sample, and determining the mobile phase solvent and the stationary phase column corresponding to the determined protocol.

The outputting of the liquid chromatography analysis result may include outputting the liquid chromatography analysis result based on an output by a detector for each material of a plurality of materials separated from the sample based on liquid chromatography.

The detector may include at least one of an ultraviolet-visible (UV-VIS) spectrophotometer, a mass spectrometer, and a charged aerosol detector (CAD).

The outputting of the liquid chromatography analysis result may include acquiring chromatography data of a plurality of materials separated from the sample based on liquid chromatography.

The instructions, when executed by the at least one processor, may further cause the electronic device to acquire mass spectra corresponding to peaks of the chromatography data, based on mass spectrometry for the plurality of materials separated.

The instructions, when executed by the at least one processor, may further cause the electronic device to determine a peak corresponding to the target material among peaks detected from the chromatography data based on the acquired mass spectra.

### BRIEF DESCRIPTION OF DRAWINGS

The above and/or other aspects will be more apparent by describing embodiments with reference to the accompanying drawings, in which:

FIG. 1 is a diagram illustrating a material analysis system according to one or more embodiments;

FIG. 2 is a diagram illustrating a liquid chromatography (LC) device and a detector according to one or more embodiments;

FIG. 3 is an operation flowchart illustrating a material analysis method based on liquid chromatography according to one or more embodiments;

FIG. 4 is a diagram illustrating measurement data based on liquid chromatography and mass spectrometry according to one or more embodiments;

FIG. 5 is a diagram illustrating a training model configured to output a protocol according to one or more embodiments; and

FIG. 6 is an exemplary diagram illustrating a configuration of an electronic device according to one or more embodiments.

### DETAILED DESCRIPTION

The following detailed structural or functional description is provided as an example only and various alterations and modifications may be made to the examples. Accordingly, the example embodiments are not construed as limited to the disclosure and should be understood to include all changes, equivalents, and replacements within the idea and the technical scope of the disclosure.

With regard to the description of the drawings, similar reference numerals may be used to refer to similar or related components. It is to be understood that a singular form of a noun corresponding to an item may include one or more of the things, unless the relevant context clearly indicates otherwise.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Terms, such as “first” or “second”, are simply used to distinguish a component from another component and do not limit the components in other aspects (e.g., importance or sequence).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the examples with reference to the accompanying drawings, like reference numerals refer to like elements and a repeated description related thereto will be omitted.

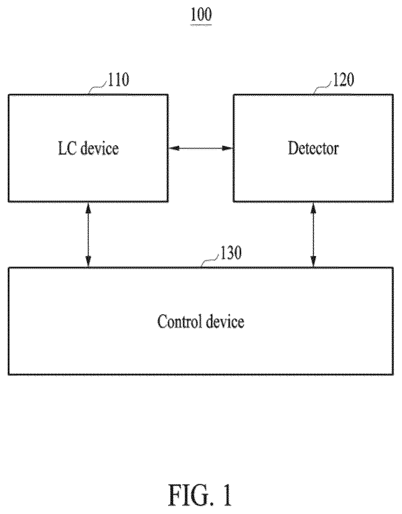

FIG. 1 is a diagram illustrating a material analysis system according to one or more embodiments.

Referring to FIG. 1, a material analysis system 100 may include a liquid chromatography (LC) device 110, a detector 120, and a control device 130.

The material analysis system 100 may perform analysis on material(s) included in a sample. The sample may be a mixture of a plurality of starting materials and a product synthesized by causing the starting materials to react. For example, when a product is synthesized by a reaction between a first starting material and a second starting material, the sample may include a mixture of the first starting material, the second starting material, and the product. The sample may include at least one of monomolecular substances and organic materials, for example.

The material analysis system 100 may analyze the sample under a specific measurement condition. The material analysis system 100 may automatically determine a measurement condition for analyzing a sample. The measurement condition for analyzing a sample may be referred to as a protocol. The efficiency and accuracy of sample separation and detection may vary depending on the protocol to be described below.

The LC device 110 may perform liquid chromatography on a sample. The LC device 110 may perform liquid chromatography on a sample and may separate a plurality of materials from the sample. A sample may include a plurality of materials. The sample may be a mixture including one or more target materials.

Chromatography may refer to the separation or elution of a plurality of materials from a sample. The liquid chromatography may refer to a chromatography where a mobile phase is liquid. For example, the liquid chromatography may refer to a separation of a sample by passing a liquid mobile phase mixed with the sample through a stationary phase. In the liquid chromatography, a sample dissolved in a mobile phase solvent may be eluted into a plurality of materials by interaction of the sample, a stationary phase, and a mobile phase. A material eluted from the sample may be a monomolecular substance, but embodiments are not limited thereto.

The liquid chromatography may be performed based on a protocol selected for the elution of the sample. The protocol may refer to a condition set for material separation from the sample based on the liquid chromatography. For example, the protocol may include at least one of the type of stationary phase column, the type of mobile phase solvent, a required flow rate, the type of detector, and a column temperature. The selection of protocol is described in detail below.

A sample may be separated into a plurality of materials by liquid chromatography in the LC device 110, and the detector 120 may detect the characteristics of the separated materials. The detector 120 is a device for analyzing a material separated from a sample by liquid chromatography and may include a device for identifying or quantifying the material separated from the sample. For example, the detector 120 may include at least one of a mass spectrometer, an ultraviolet-visible (UV-VIS) spectrophotometer, and a charged aerosol detector (CAD).

The material analysis system 100 may include an interface (e.g., a fluid path) between the LC device 110 and the detector 120. A sample for which liquid chromatography has been completed in the LC device 110 may be transmitted to the detector 120 through the interface. The interface between the LC device 110 and the detector 120 may be, for example, the fluid path, but embodiments are not limited thereto. Materials separated in the LC device 110 may be transmitted along the fluid path to the detector 120. Thus, liquid chromatography on a sample and the analysis of a separated material may be performed sequentially with a relatively small delay.

The control device 130 is a device for controlling the material analysis system 100 and may include one or more processors. The control device 130 may generate a control signal for controlling the LC device 110 and/or the detector 120. The control signal generated by the control device 130 may be transmitted to the LC device 110 and/or the detector 120. The LC device 110 and/or the detector 120 may be controlled to perform an operation instructed by a control signal, based on the control signal received from the control device 130. The specific operation of the control device 130 and the operation of controlling the LC device 110 and/or the detector 120 by the control signal of the control device 130 are described in detail below.

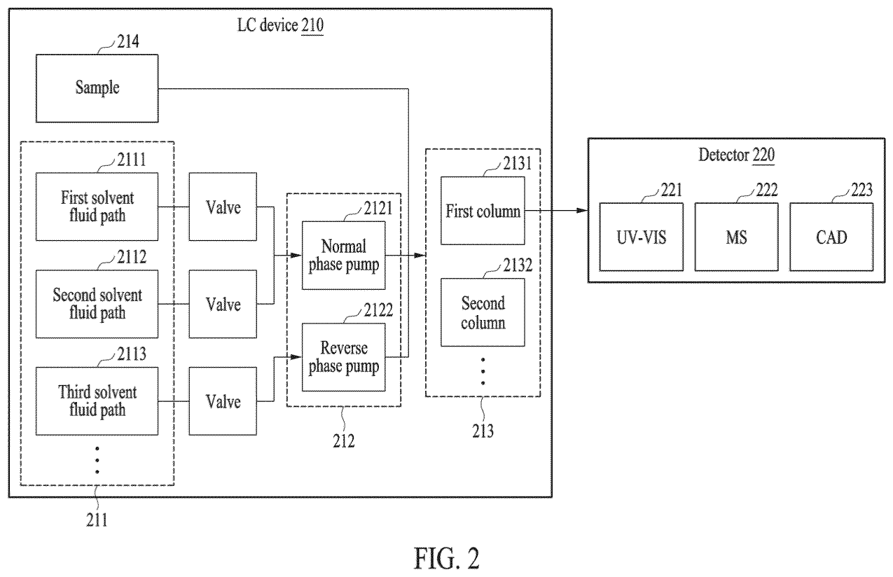

FIG. 2 is a diagram illustrating an LC device and a detector according to one or more embodiments.

An LC device 210 shown in FIG. 2 may correspond to the LC device 110 of FIG. 1. A detector 220 shown in FIG. 2 may correspond to the detector 120 of FIG. 1.

Referring to FIG. 2, the LC device 210, according to one or more embodiments, may include one or more solvent fluid paths 211. For example, the solvent fluid paths 211 may include a first solvent fluid path 2111, a second solvent fluid path 2112, and a third solvent fluid path 2113. Each of the solvent fluid paths 211 may correspond to a fluid path into which a specific solvent is injected or a fluid path containing the specific solvent. For example, a first solvent may be injected into the first solvent fluid path 2111, a second solvent may be injected into the second solvent fluid path 2112, and a third solvent may be injected into the third solvent fluid path 2113. The first solvent, the second solvent and the third solvent may be different types of solvents.

The LC device 210 may include a pump 212 configured to generate a mobile phase solvent, which is a mixture including one or more solvents. For example, a mobile phase may be a mixture of water and an organic solvent (e.g., methanol or acetone acetone). For another example, the mobile phase may be a mixture of a polar solvent (e.g., hexane) and a non-polar solvent (e.g., ethyl acetate).

For example, the pump 212 may include a normal phase pump 2121 and a reverse phase pump 2122. A solvent path including a high polar or hydrophilic solvent may be connected to the normal phase pump 2121. A solvent path including a relatively low polar or hydrophobic solvent may be connected to the reverse phase pump 2122.

The solvent fluid path 211 and the pump 212 may be connected by a valve. The composition of a mobile phase solvent may be determined by controlling the opening and closing of a valve connected to each solvent fluid path. The opening and closing of a valve may be controlled based on a signal generated by a control device (e.g., the control device 130 of FIG. 1).

The LC device 210 may determine the mobile phase solvent by mixing at least some of the solvents (e.g., water, organic solvents, or mixtures thereof) included in the solvent fluid path 211. The mobile phase solvent may be determined based on a protocol. Based on the protocol, the control device may generate a signal to control a valve connected to some of the solvent fluid path 211 to open and a signal to control valves connected to the remaining solvent fluid paths to close. The opening and closing of the valve connected to the solvent fluid path 211 may be controlled by the signal that controls the opening and closing of the valve generated by the control device.

The mobile phase solvent is a solvent that moves a sample 214 through a column 213, and a mixture of the sample 214 and a candidate solvent or a combination of candidate solvents may also be referred to as an eluent. For example, the LC device 210 may inject the sample 214 into the mobile phase solvent by using an autosampler.

The LC device 210 may include one or more columns 213. The columns 213 are tubes including stationary phases and may be referred to as stationary phase columns. For example, the columns 213 may include a first column 2131 including a first stationary phase material and a second column 2132 including a second stationary phase material. The first stationary phase material and the second stationary phase material may be different types of materials. For example, the types of columns 213 may include a relatively high polar or hydrophilic normal phase and a low polar or hydrophobic reverse phase.

Depending on the characteristics of the mobile phase solvent, any one of the columns 213 may be selected as a column into which the mobile phase solvent is injected. The selection of the columns 213 may be determined based on a control signal received from the control device. For example, when the mobile phase solvent is a relatively low polar solvent (e.g., hexane or chloroform), a stationary phase column of a relatively high polar material (e.g., silica gel or alumina) may be selected. For example, when the mobile phase solvent is a relatively high polar solvent (e.g., water, methanol, or acetonitrile), a stationary phase column of a relatively low polar material (e.g., a material in which C18, C8, or C4 hydrocarbon, that is, a hydrophobic compound, is bonded to a silica gel surface) may be selected.

An eluent, which is a mixture of the sample 214 and the mobile phase solvent, may be injected into a selected column. For example, the LC device 210 may transmit the eluent to any one of the columns 213 at a desired flow rate by using the pump 212. The mobile phase flow rate may refer to the amount of a mobile phase passing through the column 213.

In the column 213, materials included in the sample 214 may be separated depending on an interaction between a mobile phase, which is an eluent, and a stationary phase. For example, with the eluent including the sample 214 passing through the column 213, a plurality of materials included in the sample 214 may be separated. This is due to a plurality of different materials included in the sample 214 moving at different speeds depending on an interaction between an eluent and a stationary phase.

The materials separated from the sample 214 may be transmitted to the detector 220. As described above, since materials are separated based on different speeds in passing through a stationary phase, the time when each separated material reaches the detector 220 may vary. The detector 220 may record the characteristics of a material measured at each time.

The detector 220 may include a UV-VIS spectrophotometer 221. The UV-VIS spectrophotometer 221 may measure the ultraviolet-visible light absorbance of a material. Materials separated from the sample 214 may be input to the UV-VIS spectrophotometer 221 at different times. The UV-VIS spectrophotometer 221 may irradiate (emit) an ultraviolet-visible light to an input material and may record the difference of a transmitted light compared to the intensity of the irradiated light as absorbance (e.g., adsorption intensity information) at each time. The UV-VIS spectrophotometer 221 may output the absorbance of each separated material. Based on the absorbance of a material, concentration or structure information of the material may be acquired.

The detector 220 may include a mass spectrometer (MS) 222. The mass spectrometer 222 may measure a mass-to-charge ratio (m/z) of an ionized material. Ionized materials may be separated by each charge ratio. The mass spectrometer 222 may detect and record the counts (e.g., ion counts) of separated ionized materials by each mass-to-charge ratio (m/z). The mass spectrometer 222 may record the ion counts by each mass-to-charge ratio (m/z) for an input material at a specific time. For example, materials separated from the sample 214 may be input to the mass spectrometer 222 at different times. The mass spectrometer 222 may measure and record the mass-to-charge ratio (m/z) of an input material at each time and may record the ion counts by each mass-to-charge ratio (m/z).

The detector 220 may include a CAD 223. A CAD may measure an electric charge of a charged aerosol particle by spraying a material in a gaseous state. Materials separated from the sample 214 may be input to the CAD 223 at different times. The CAD 223 may measure and record an electric charge of an aerosol particle of an input material at each time.

According to one or more embodiments, a separated material may be input to the UV-VIS spectrophotometer 221 or the CAD 223 selectively. For example, a material that absorbs an ultraviolet-visible light may be input to the UV-VIS spectrophotometer 221, and a material that does not absorb an ultraviolet-visible light may be input into the CAD 223. For example, when a target material includes a specific structure (e.g., a benzene ring), materials separated from the sample 214 may be input to the UV-VIS spectrophotometer 221, and, when the target material does not include the specific structure (e.g., the benzene ring), the materials separated from the sample 214 may be input to the CAD 223.

Whether the materials separated from the sample 214 are input to the UV-VIS spectrophotometer 221 may be determined based on a control signal from the control device. Whether the materials separated from the sample 214 are input to the mass spectrometer 222 may be determined based on a control signal from the control device. Whether the materials separated from the sample 214 are input to the CAD 223 may be determined based on a control signal from the control device. For example, the control device may determine to which detector 220 the materials separated from the sample 214 are input, based on the protocol. For example, the control device may determine to which detector 220 the materials separated from the sample 214 are input, based on information on the target material.

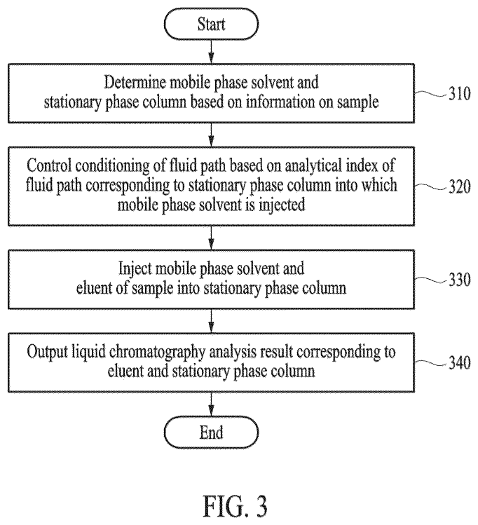

FIG. 3 is an operation flowchart illustrating a material analysis method based on liquid chromatography according to one or more embodiments.

The material analysis method based on liquid chromatography according to one or more embodiments may be performed by at least one processor included in an electronic device. For example, the electronic device that performs the material analysis method based on liquid chromatography may include the control device 130 of the material analysis system 100 described above with reference to FIG. 1. Hereinafter, the material analysis method based on liquid chromatography is described as performed by a control device. Hereinafter, the material analysis method based on liquid chromatography may be referred to as the material analysis method.

Referring to FIG. 3, the material analysis method according to one or more embodiments may include operation 310 of determining a mobile phase solvent and a stationary phase column based on information on a sample.

The information on a sample may include information on a target material expected to be included in the sample. For example, the information on a target material may include simplified molecular input line entry system (SMILES) data of the target material. The SMILES data may be data representing a material structure as an atom, a bond, a ring, an aromaticity, and a branch as an element of a molecular structure.

According to one or more embodiments, operation 310 of determining a mobile phase solvent and a stationary phase column may include determining a protocol based on the information on a target material corresponding to a sample and determining a mobile phase solvent and a stationary phase column corresponding to the determined protocol.

According to one or more embodiments, the protocol may be determined based on a value (e.g., a partition coefficient) calculated from the SMILES data of the target material. For example, a partition coefficient LogP representing how a compound is partitioned between a non-polar organic solvent (e.g., octanol) and water may be calculated (obtained) from the SMILES data using cheminformatics software such as RDKit. Based on the calculated (obtained) partition coefficient, the protocol may be determined. For example, a PR1-1 protocol may be selected if the partition coefficient LogP calculated (obtained) from the SMILES data of the target material is less than a threshold (e.g., 8). If the partition coefficient Log P is greater than the threshold (e.g. 8), a PR 2-2 protocol may be selected.

According to one or more embodiments, a training model that receives the information on a sample as an input and outputs a protocol may be used to select a protocol corresponding to the information about a sample. The training model may include a neural network trained to output a protocol corresponding to a feature extracted from the information on a target material corresponding to the sample (e.g., SMILES data). Hereinafter, the information on a target material is described as, for example, SMILES data. The information on a target material may include various types of information to identify, characterize, or describe the target material and is not limited to the SMILES data.

For example, one or more features based on a two-dimensional or three-dimensional structure of a material may be extracted from the SMILES data. The features extracted from the SMILES data may include, for example, at least one of the number of atoms of a material, the partition coefficient Log P, a molecular weight, the number of free radical electrons, the number of valence electrons, the number of ring structures, a molecular volume, a molecular surface area, a dipole moment, an energy state of a molecule, and a chirality. The training model that outputs a protocol is described in detail below.

The protocol may include information indicating a mobile phase solvent and a stationary phase column. The mobile phase solvent and the stationary phase column for analysis of a sample may be determined by the protocol. The control device may generate a signal to control an LC device (e.g., the LC device 110 of FIG. 1 or the LC device 210 of FIG. 2) such that the mobile phase solvent indicated by the protocol is injected into the stationary phase column indicated by the protocol.

The material analysis method according to one or more embodiments may include operation 320 of controlling the conditioning of a fluid path based on an analytical index of the fluid path corresponding to a stationary phase column into which a mobile phase solvent is injected. The fluid path may include a fluid path leading to a pump, a column, and a detector (e.g., the detector 120 of FIG. 1 or the detector 220 of FIG. 2) through which the mobile phase solvent passes. The fluid path may be conditioned as the determined mobile phase solvent flows through the fluid path. The conditioning of a fluid path may refer to the injecting of a mobile phase solvent into the fluid path to ensure that no impurities (e.g., an eluent containing previous samples) remain in the fluid path. The conditioning of a fluid path may refer to the injecting of a mobile phase solvent into the fluid path to determine whether the fluid path is defective.

The analytical index of the fluid path may include a pump pressure to move the mobile phase solvent through the fluid path. For example, the pump pressure may include a pump pressure to move the mobile phase solvent into the stationary phase column. The control device may monitor the pump pressure as the determined mobile phase solvent flows into the fluid path.

For example, the control device may determine that no leak has been caused by a defect in the fluid path when a measured pump pressure remains within a certain range when the determined mobile solvent flows into the fluid path. The control device may determine that the conditioning of the fluid path is completed when the measured pump pressure remains within the certain range while the determined mobile solvent flows into the fluid path. The control device may control conditioning to be continued by continuously injecting a mobile phase solvent into the fluid path when the measured pump pressure is outside the certain range or exhibits an unstable value while the determined mobile phase solvent flows into the fluid path. As another example, the control device may stop the execution of the material analysis method when the measured pump pressure is outside the certain range or exhibits an unstable value when the determined mobile phase solvent flows into the fluid path.

For example, the control device may control the conditioning of the fluid path based on a type of measured pump pressure as the determined mobile phase solvent flows into the fluid path. A mobile phase may have different pump pressure types depending on a combination of solvents. The control device may determine whether a type of pump pressure measured if the determined mobile phase solvent flows into the fluid path corresponds to a type of pump pressure corresponding to the determined mobile phase solvent. When the type of pump pressure measured when the determined mobile phase solvent flows into the fluid path corresponds to the type of pump pressure corresponding to the determined mobile phase solvent, the conditioning of the fluid path is determined to be completed. When the type of pump pressure measured when the determined mobile phase solvent flows into the fluid path does not correspond to the type of pump pressure corresponding to the determined mobile phase solvent, the control device may control conditioning to be continued by continuously injecting a mobile phase solvent to the fluid path. As another example, the control device may stop the execution of the material analysis method when the type of pump pressure measured when the determined mobile phase solvent flows into the fluid path does not correspond to the type of pump pressure corresponding to the determined mobile phase solvent.

The analytical index of the fluid path may include an output of the detector. The control device may monitor an output of the detector regarding the result of passing a mobile phase solvent through a stationary phase column. Whether any impurities are included may be determined through the output of the detector. For example, the control device may determine whether an impurity is included by monitoring whether an intensity that is a certain level or more than a predetermined baseline is detected based on data that is output from the detector. When the mobile phase solvent is passed through the stationary phase column without a sample, when an intensity that is the certain level or more than the baseline is detected, the mobile phase solvent or the stationary phase column may be determined to include an impurity. For example, the control device may monitor the output of a UV-VIS spectrophotometer and may determine that an impurity is included when a peak of an ultraviolet-visible light absorbance that is the certain level or more than the predetermined baseline is detected. For example, the control device may monitor the output of a mass spectrometer and may determine that an impurity is included when a count value for a specific mass-to-charge ratio (m/z) is greater than or equal to a threshold value (e.g., 10\hat{ }5). For example, the control device may monitor an output of a CAD and may determine that an impurity is included when an electric charge that is a certain level or more than the predetermined baseline is detected.

The control device may determine that the conditioning of the fluid path is completed when no impurities are detected based on the output of the detector. The control device may control the conditioning to be continued by continuously injecting a mobile phase solvent into the fluid path when the detector determines that an impurity has been detected.

According to one or more embodiments, whether the conditioning of a fluid path is completed may be determined sequentially based on each of analytical indices of a plurality of fluid paths. For example, whether the conditioning of a flow path is completed may be determined first based on a pump pressure, and, when the conditioning of the fluid path is determined to be completed based on the pump pressure, whether the conditioning is completed may be determined based on the output of the detector. The control device may control the LC device to continue to inject a mobile phase solvent through the fluid path until the conditioning is determined to be completed.

The material analysis method according to one or more embodiments may include operation 330 of injecting a mobile phase solvent and an eluent of a sample into a stationary phase column. As described above, the eluent may be a mixture of a solvent and a sample.

According to one or more embodiments, operation 330 of injecting an eluent into a stationary phase column may include determining whether the sample includes a target material based on the result of measuring a mass-to-charge ratio (m/z) of the sample and injecting the eluent into the stationary phase column based on the result of the determination. For example, by injecting the sample into a mass spectrometer prior to liquid chromatography analysis of the sample, whether the sample includes the target material may be determined from a measurement result of a mass-to-charge ratio (m/z) of the sample. For example, the mass-to-charge ratio (m/z) of the target material may be predetermined. When an ion count of the mass-to-charge ratio (m/z) of the target material in output data of the mass spectrometer for the sample is greater than a certain count, the target material may be determined to be included in the sample.

When the target material is determined to be included in the sample based on the measurement result of the mass-to-charge ratio (m/z), the injecting of the eluent into the stationary phase column may be performed. When the target material is determined to be not included in the sample based on the measurement result of the mass-to-charge ratio (m/z), analysis for that sample may be stopped. When the target material is determined to be not included in the sample, operation 310 may be performed on the next sample.

The method according to one or more embodiments may include operation 340 of outputting a liquid chromatography analysis result corresponding to the eluent and the stationary phase column. The liquid chromatography analysis result may include analytical data on materials separated from a sample. The materials separated from a sample may be acquired from the liquid chromatography corresponding to the eluent and the stationary phase column.

According to one or more embodiments, operation 340 of outputting a liquid chromatography analysis result may include outputting the liquid chromatography analysis result based on an output of a detector for a plurality of materials separated from a sample based on liquid chromatography. The analytical data on materials separated from the sample may include data based on the output of the detector (e.g., the detector 120 of FIG. 1 or the detector 220 of FIG. 2). As described above, the detector may include at least one of a mass spectrometer, a UV-VIS spectrophotometer, and a CAD.

For example, the liquid chromatography analysis result may include the output of the detector for the plurality of materials separated from the sample based on liquid chromatography. For example, the liquid chromatography analysis result may include absorbance measurement data for each material that is output from the UV-VIS spectrophotometer. For example, the liquid chromatography analysis result may include the measurement data of a mass-to-charge ratio (m/z) corresponding to each material that is output from the mass spectrometer. For example, the liquid chromatography analysis result may include the charge measurement data of a charged aerosol particle of each material that is output from the CAD.

For example, the liquid chromatography analysis result may include analytical data based on the output of the detector. For example, the liquid chromatography analysis result may include the determination of whether the target material is included based on the output of the detector. For example, the liquid chromatography analysis result may include a quantitative analysis result of the target material based on the output of the detector.

According to one or more embodiments, operation 340 of outputting a liquid chromatography analysis result may include acquiring the chromatography data of the plurality of materials separated from the sample based on liquid chromatography.

The liquid chromatography analysis result may include chromatography data representing an intensity corresponding to a time axis. The chromatography data may represent an intensity that is detected or measured by the detector by inputting the plurality of materials separated from the sample based on liquid chromatography into the detector at each time. The chromatographic data may include a peak corresponding to each material. The peak may be a sharp portion of the chromatographic data represented with an increase or decrease in intensity at each time and may be a portion showing a higher intensity than an intensity baseline. In the chromatography data, a peak may be represented at the time when a material separated from the sample is input to the detector. A time interval corresponding to the peak may be referred to as a retention time.

According to one or more embodiments, the acquiring of chromatography data may include acquiring chromatography data corresponding to an ultraviolet-visible light absorbance of the plurality of materials separated from the sample based on liquid chromatography. The chromatography data may represent the ultraviolet-visible light absorbance of the materials separated based on liquid chromatography that are input to the UV-VIS spectrophotometer at each time and measured by the detector.

According to one or more embodiments, the acquiring of chromatography data may include acquiring chromatography data corresponding to an electric charge of a charged aerosol of the plurality of materials separated from the sample based on liquid chromatography. The chromatography data may be an electric charge of a charged aerosol of each material that is measured by the detector after the materials separated based on liquid chromatography are input to the CAD at each time.

According to one or more embodiments, operation 340 of outputting a liquid chromatography analysis result may include acquiring mass spectra corresponding to peaks of chromatography data based on mass spectrometry of the plurality of materials separated. Although a material corresponding to each peak may not be identified with a peak of the chromatography data alone, the material may be identified based on a mass spectrum of the material corresponding to the peak of the chromatography data.

According to one or more embodiments, operation 340 of outputting a liquid chromatography analysis result may include determining, based on the acquired mass spectra, a peak corresponding to the target material from among the peaks detected in the chromatography data. Based on the mass spectra corresponding respectively to the peaks and a predetermined mass pattern of the target material, the peak corresponding to the target material may be identified.

When the peak corresponding to the target material is identified in the chromatography data, the target material may be determined to be included in the sample. In this case, the material analysis method may be performed on the next sample.

When the peak corresponding to the target material is not identified in the chromatography data, the target material may be determined to be not included in the sample. In this case, the liquid chromatography analysis result for that sample may include a result indicating failure. In this case, the control device may control a system (e.g., the system 100 of FIG. 1) such that the material analysis method may be performed again by a changed protocol. For example, the control device may reselect a protocol based on information on the target material corresponding to the sample. The control device may perform operations 310 to 340 again based on the reselected protocol.

According to one or more embodiments, operation 340 of outputting a liquid chromatography analysis result may include determining an analytical index of a plurality of materials separated from a sample based on liquid chromatography based on information on the sample and outputting an analysis result of the determined analytical index corresponding to the plurality of materials. For example, based on the SMILES data of a target material predicted to be included in the sample, an analytical index may be determined for the plurality of materials separated from the sample.

For example, when the target material for the sample is determined to include a material (e.g., a material including a benzene ring) that absorbs an ultraviolet-visible light, an ultraviolet-visible light absorbance may be determined as the analytical index. When the ultraviolet-visible light absorbance is determined as the analytical index, the control device may control the plurality of materials separated from the sample based on liquid chromatography to be input to the UV-VIS spectrophotometer. The ultraviolet-visible light absorbance of each material output from the UV-VIS spectrophotometer may be output as the analysis result.

For example, when the target material included in the sample is determined to not include a material that absorbs an ultraviolet-visible light, an electric charge of a charged aerosol particle may be determined as the analytical index. When the electric charge of a charged aerosol particle is determined as the analytical index, the control device may control the plurality of materials separated from the sample based on liquid chromatography to be input to the CAD. The electric charge of each charged aerosol particle output from the CAD may be output as the analysis result.

For example, when the target material for the sample is a mixture, the target material may include both a material that absorbs an ultraviolet-visible light and a material that does not absorb an ultraviolet-visible light. Thus, both an ultraviolet-visible light absorbance and the electric charge of a charged aerosol particle may be determined as the analytical indices. In this case, the control device may control the plurality of materials separated from the sample based on liquid chromatography to be input to the UV-VIS spectrophotometer and the CAD. The electric charge of a charged aerosol particle of each material output from the UV-VIS spectrophotometer and the CAD may be output as the analysis result.

Whether a material that absorbs an ultraviolet-visible light is only an example of a criterion for determining an analytical index. The analytical index may be determined from various features of the target material derived from the information on the sample.

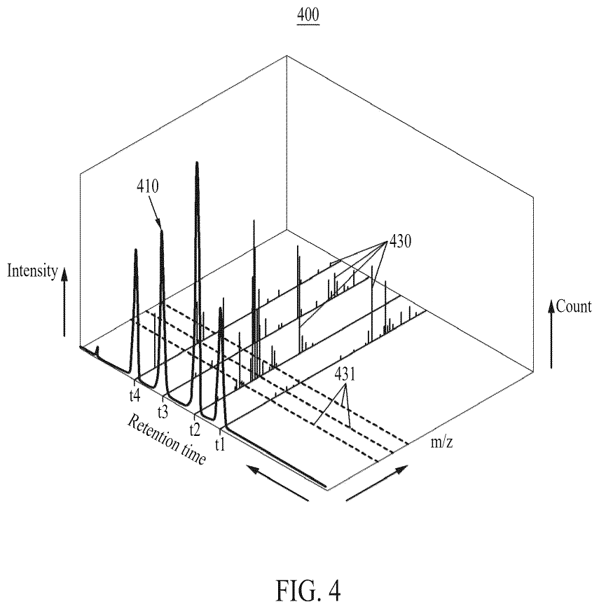

FIG. 4 is a diagram illustrating measurement data based on liquid chromatography and mass spectrometry according to one or more embodiments.

Measurement data 400 according to one or more embodiments may include chromatography data based on liquid chromatography and mass spectrometry data based on a mass spectrometer.

The chromatography data may include a liquid chromatogram 410. The horizontal axis of the liquid chromatogram 410 may represent a retention time and the vertical axis may represent an intensity. Referring to FIG. 4, the intensity of the liquid chromatogram 410 is described as, for example, the case of an ultraviolet-visible light absorbance. The liquid chromatogram 410 may represent the ultraviolet-visible absorbance of materials separated at each time.

The materials separated from a sample may be passed through a UV-VIS spectrophotometer and then through the mass spectrometer. The mass spectrometer may generate mass spectrometry data by ionizing a separated material and measuring a mass-to-charge ratio (m/z) of the ionized material and a count (e.g., an ion count) of the mass-to-charge ratio (m/z) of the ionized material. The mass spectrometry data may also be referred to as total ion chromatogram (TIC) data.

Four peaks are illustrated as an example in the liquid chromatogram 410 of FIG. 4. The four peaks may be detected at specific time points t1, t2, t3, and t4. The mass spectrometer may perform a scan for mass spectrometry at each time point (e.g., t1, t2, t3, or t4) where a peak appears in the liquid chromatogram 410. The mass spectrometer may generate TIC data corresponding to each liquid chromatogram 410 at each time point (e.g., t1, t2, t3, or t4) where a peak appears.

The TIC data may represent all mass spectrum intensities belonging to the same scan (e.g., a scan at a specific time point). For example, a mass spectral intensity corresponding to a specific mass-to-charge ratio (m/z) may be the number (e.g., an ion count) of ions detected at that specific mass-to-charge ratio (m/z). In the TIC data, the horizontal axis may represent time (or a mass-to-charge ratio (m/z)), and the vertical axis may represent an ion count. Each time point in the time axis of TIC data may correspond to a mass-to-charge ratio (m/z). The time of the ionized material to reach the detector may vary depending on the mass of the material. For example, FIG. 4 describes an example in which the horizontal axis of the TIC data is interpreted as the mass-to-charge ratio (m/z) instead of time. In addition, FIG. 4 illustrates a mass spectrum integrated with mass spectrometry data of time points belonging to the same peak in the liquid chromatogram 410 is illustrated.

The mass spectrometer may output a mass spectrum for each peak in the liquid chromatogram 410. For example, the mass spectrum may represent an accumulated ion count during a retention time corresponding to a corresponding peak by a mass to charge ratio within a mass to charge ratio scan range. The resolution of the mass spectrum may vary depending on the specification of the mass spectrometer.

Peaks corresponding to some mass-to-charge ratios (m/z) may be extracted from the mass spectrum 430. For example, mass-to-charge ratio (m/z) values of some isotopes of a target material may be determined to be values of interest. For example, three mass-to-charge ratio (m/z) values 431 corresponding to the top three isotopes of the target material may be determined to be the values of interest. Peaks corresponding to the three mass-to-charge ratio (m/z) values 431 determined to be the values of interest may be extracted from the mass spectrum 430. For example, when the target material corresponds to a peak at the time point t1, the peaks corresponding to the three mass-to-charge ratio (m/z) values 431 determined to be the values of interest from the mass spectrum 430 corresponding to the peak at the time point t1 may be identified as a detection result corresponding to the target material.

When the mass spectrum 430 includes a peak corresponding to the target material, the target material may be determined to be included in the sample. Among the materials separated from the sample, a substance that exhibits a peak identified as the detection result of the target material may be acquired as the target material.

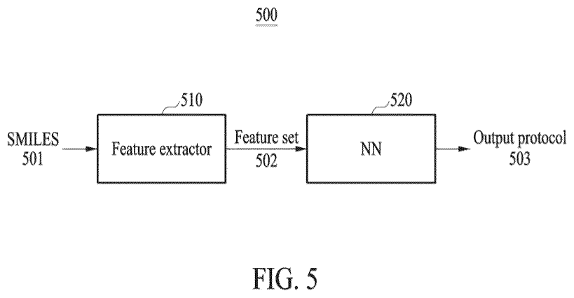

FIG. 5 is a diagram illustrating a training model configured to output a protocol according to one or more embodiments.

Referring to FIG. 5, a training model 500 for determining the protocol may include a feature extractor 510 and a neural network (NN) 520. The feature extractor 510 may extract one or more features from SMILES data 501 of an input target material. As described above, the features extracted from the feature extractor 510 are one or more features based on a two-dimensional or three-dimensional structure of a material corresponding to the SMILES data 501 and may include at least one of, for example, the number of atoms of the material, the partition coefficient Log P, a molecular weight, the number of free radical electrons, the number of valence electrons, the number of ring structures, a molecular volume, a molecular surface area, a dipole moment, the energy state of a molecule, and a chirality.

At least some of the features extracted from the feature extractor 510 may be determined to be a feature set 502. The feature set 502 may correspond to a set including one or more features extracted from the feature extractor 510. For example, the feature set 502 may include a feature corresponding to the number of atoms of the material, a feature corresponding to the partition coefficient Log P, a feature corresponding to the molecular weight, a feature corresponding to the number of free radical electrons, and a feature corresponding to the number of valence electrons.

The feature set 502 may be determined based on the accuracy of an output protocol 503 acquired from the NN 520. For example, the accuracy of the output protocol 503 acquired from the NN 520 may be measured for each of a plurality of feature sets having different combinations of included feature(s). For example, the plurality of feature sets having different combinations of the included feature(s) may include a first feature set including a first feature and a second feature and a second feature set including the first feature and a third feature. The accuracy of the output protocol 503 may be determined by whether a target material is detected after performing liquid chromatography according to the output protocol 503. As another example, the accuracy of the output protocol 503 may be determined with a similarity to the ground truth (GT) of the output protocol 503 corresponding to an input target material. As the similarity between the GT of the output protocol 503 corresponding to the input target material and the output protocol 503 acquired corresponding to the SMILES data 501 of the target material in the NN 520 is higher, the accuracy of the output protocol 503 may be determined to be higher.

The feature set 502 may be applied to the NN 520. The NN 520 may include a plurality of parameters whose values are determined through training. The NN 520 may generate the output protocol 503 corresponding to the input feature set 502.

As described above, when a peak corresponding to the target material is not identified in chromatography data, the target material may be determined to be not included in a sample. In this case, the control device may reselect a protocol for the sample to perform a material analysis method again on the same sample. For example, the control device may reselect the protocol corresponding to the sample by using the training model 500. The control device may change the feature set 502 and may determine the output protocol 503 acquired in the NN 520 as a changed protocol corresponding to the changed feature set 502. For example, where the accuracy of the first protocol acquired in the NN 520 corresponding to the first feature set is the highest, and liquid chromatography and analysis thereof based on the first protocol are performed, but the target material is not detected, a second protocol acquired in the NN 520 corresponding to the second feature set with the next highest accuracy may be determined to be the next protocol.

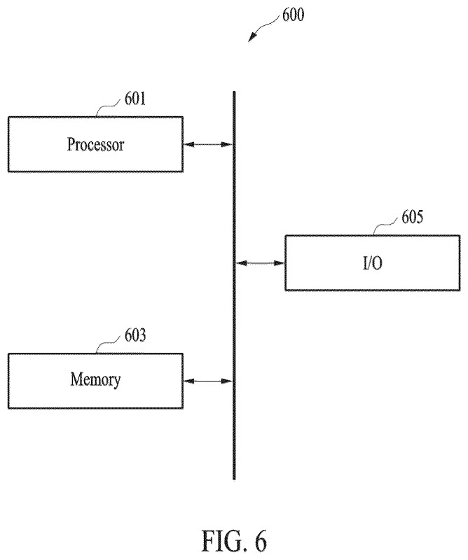

FIG. 6 is an exemplary diagram illustrating a configuration of an electronic device according to one or more embodiments.

Referring to FIG. 6, an electronic device 600 according to one or more embodiments includes a processor 601, a memory 603, and an input/output (I/O) device 605. The electronic device 600 according to one or more embodiments may include a device configured to perform the material analysis method described above with reference to FIGS. 1 to 5. For example, the electronic device 600 may include the control device 130 of FIG. 1.

The processor 601 according to one or more embodiments may perform at least one operation of the material analysis method described above with reference to FIGS. 1 to 5. For example, the processor 601 may perform at least one operation of determining a mobile phase solvent and a stationary phase column based on information on a sample, controlling the conditioning of a fluid path based on an analytical index of the fluid path corresponding to the stationary phase column into which the mobile phase solvent is injected, injecting the mobile phase solvent and an eluent of the sample into the stationary phase column, and outputting a liquid chromatography analysis result corresponding to the eluent and the stationary phase column.

The memory 603 according to one or more embodiments may be a volatile memory or a non-volatile memory and may store data related to the material analysis method described above with reference to FIGS. 1 to 5. For example, the memory 603 may store data generated during the process of performing the material analysis method described above with reference to FIGS. 1 to 5 or data required to perform the material analysis method.

The I/O device 605 according to one or more embodiments may include an input device and an output device. The information on a sample may be input through the input device of the I/O device 605. A control signal for controlling the material analysis system 100 may be output through the output device of the I/O device 605.

According to one or more embodiments, the memory 603 may not be a component of the electronic device 600 but may be included in an external device accessible by electronic device 600. In this case, the electronic device 600 may receive data stored in the memory 603 included in the external device through a communication device and may transmit data to be stored in the memory 603.

According to an example, the memory 603 may store a program configured to implement the material analysis method described above with reference to FIGS. 1 to 5. The processor 601 may execute a program stored in the memory 603 and may control the electronic device 600. Code from the program executed by the processor 601 may be stored in the memory 603.

According to an example, the memory 603 may store instruction(s). The instruction(s) stored in the memory 603, when executed by the one or more processors 601, may cause the electronic device 600 to determine a mobile phase solvent and a stationary phase column based on information on a sample, control conditioning of a fluid path based on an analytical index of the fluid path corresponding to the stationary phase column into which the mobile phase solvent is injected, inject the mobile phase solvent and an eluent of the sample into the stationary phase column, and output a liquid chromatography analysis result corresponding to the eluent and the stationary phase column.

The electronic device 600 according to one or more embodiments may further include other components not shown in the drawings. For example, the electronic device 600 may include a communication device that provides a function for the electronic device 600 to communicate with other electronic devices or servers via a network. In addition, for example, the electronic device 600 may further include other components such as a transceiver, various sensors, and a database.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular, however, a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or collectively instruct or configure the processing unit to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims and their equivalents.

While embodiments have been described with reference to the figures, it will be understood by those of ordinary skill in the art that various changes in form and details may be made therein without departing from the spirit and scope as defined by the following claims and their equivalents.

What is claimed is:

1. A method of analyzing a material based on liquid chromatography, the method comprising:
determining a mobile phase solvent and a stationary phase column based on information of a sample;
controlling conditioning of a fluid path based on an analytical index of the fluid path corresponding to the stationary phase column configured to receive the mobile phase solvent;
injecting the mobile phase solvent and an eluent of the sample into the stationary phase column based on a determination whether the sample comprises a target material; and
outputting a liquid chromatography analysis result corresponding to the eluent and the stationary phase column.

2. The method of claim 1, wherein the injecting of the eluent into the stationary phase column comprises:
determining whether the sample comprises the target material based on a measurement result of a mass-to-charge ratio (m/z) of the sample; and
injecting the eluent into the stationary phase column based on a result of the determining.

3. The method of claim 1, wherein the determining of the mobile phase solvent and the stationary phase column comprises:
determining a protocol based on information of the target material corresponding to the sample; and
determining the mobile phase solvent and the stationary phase column corresponding to the determined protocol.

4. The method of claim 1, wherein the outputting of the liquid chromatography analysis result comprises:
outputting the liquid chromatography analysis result based on an output by a detector for each material of a plurality of materials separated from the sample based on liquid chromatography.

5. The method of claim 4, wherein the detector comprises at least one of an ultraviolet-visible (UV-VIS) spectrophotometer, a mass spectrometer, and a charged aerosol detector (CAD).

6. The method of claim 1, wherein the outputting of the liquid chromatography analysis result comprises:
acquiring chromatography data of a plurality of materials separated from the sample based on liquid chromatography.

7. The method of claim 6, wherein the acquiring of the chromatography data comprises:
acquiring chromatography data corresponding to an ultraviolet-visible absorbance of the plurality of materials separated from the sample based on liquid chromatography.

8. The method of claim 6, wherein the acquiring of the chromatography data comprises:
acquiring chromatography data corresponding to an electric charge of a charged aerosol of each material of the plurality of materials separated from the sample based on liquid chromatography.

9. The method of claim 6, further comprising acquiring mass spectra corresponding to peaks of the chromatography data, based on mass spectrometry for the plurality of materials separated.

10. The method of claim 9, further comprising determining, based on the acquired mass spectra, a peak corresponding to the target material among peaks detected from the chromatography data.

11. The method of claim 1, wherein the outputting of the liquid chromatography analysis result comprises:
based on the information of the sample, determining an analytical index of each material of a plurality of materials separated from the sample based on liquid chromatography; and
outputting an analysis result corresponding to the determined analytical index that corresponds to each material of the plurality of materials.

12. A non-transitory computer readable medium storing a computer program, when executed by at least one processor, cause an electronic device to perform a method of analyzing a material based on liquid chromatography, the method comprising:
determining a mobile phase solvent and a stationary phase column based on information of a sample;
controlling conditioning of a fluid path based on an analytical index of the fluid path corresponding to the stationary phase column configured to receive the mobile phase solvent;
injecting the mobile phase solvent and an eluent of the sample into the stationary phase column; and
outputting a liquid chromatography analysis result corresponding to the eluent and the stationary phase column.

13. An electronic device comprising:
at least one processor; and
a memory configured to store instructions,
wherein the instructions, when executed by the at least one processor, cause the electronic device to:
determine a mobile phase solvent and a stationary phase column based on information of a sample,
control conditioning of a fluid path based on an analytical index of the fluid path corresponding to the stationary phase column configured to receive the mobile phase solvent,
inject the mobile phase solvent and an eluent of the sample into the stationary phase column based on a determination whether the sample comprises a target material, and
output a liquid chromatography analysis result corresponding to the eluent and the stationary phase column.

14. The electronic device of claim 13, wherein the injecting of the eluent into the stationary phase column comprises:
determining whether the sample comprises the target material based on a measurement result of a mass-to-charge ratio (m/z) of the sample; and
injecting the eluent into the stationary phase column based on a result of the determining.

15. The electronic device of claim 13, wherein the determining of the mobile phase solvent and the stationary phase column comprises:
determining a protocol based on information of the target material corresponding to the sample; and
determining the mobile phase solvent and the stationary phase column corresponding to the determined protocol.

16. The electronic device of claim 13, wherein the outputting of the liquid chromatography analysis result comprises:
outputting the liquid chromatography analysis result based on an output by a detector for each material of a plurality of materials separated from the sample based on liquid chromatography.

17. The electronic device of claim 16, wherein the detector comprises at least one of an ultraviolet-visible (UV-VIS) spectrophotometer, a mass spectrometer, and a charged aerosol detector (CAD).

18. The electronic device of claim 13, wherein the outputting of the liquid chromatography analysis result comprises:
acquiring chromatography data of a plurality of materials separated from the sample based on liquid chromatography.

19. The electronic device of claim 18, wherein the instructions, when executed by the at least one processor, further cause the electronic device to acquire mass spectra corresponding to peaks of the chromatography data, based on mass spectrometry for the plurality of materials separated.

20. The electronic device of claim 19, wherein the instructions, when executed by the at least one processor, further cause the electronic device to determine a peak corresponding to the target material among peaks detected from the chromatography data based on the acquired mass spectra.
